(19) United States
(12) Patent Application Publication
(10) Pub. No.: US 2015/0004306 A1
(43) Pub. Date: Jan. 1, 2015

(54) METHOD FOR MANUFACTURING DISPLAY DEVICE

(71) Applicant: Samsung Display Co., Ltd., Yongin-City (KR)

(72) Inventor: Young-Min CHO, Yongin-City (KR)

(73) Assignee: Samsung Display Co., Ltd., Yongin-City (KR)

(21) Appl. No.: 14/093,953

(22) Filed: Dec. 2, 2013

(30) Foreign Application Priority Data
Jun. 27, 2013 (KR) 10-2013-0074680

(51) Int. Cl. B05D 3/12

(52) U.S. Cl. CPC B05D 3/12; B05D 2201/00; B05D 2505/50; B05D 2518/00
USPC 427/58

(57) ABSTRACT

A method for manufacturing a display device may include forming a plurality of plastic films on a carrier substrate using a mask member. The plastic films may be spaced from each other and may include a first plastic film. The method may further include forming a display unit that includes a plurality of pixels on each of the plastic films, wherein a first display unit may be formed on the first plastic film. The method may further include separating the carrier substrate from the plastic films to obtain a plurality of display devices that includes the display device. The display device may include the first plastic film and the first display unit.

### RELATED APPLICATIONS

This application claims priority to and the benefit of Korean Patent Application No. 10-2013-0074680 filed in the Korean Intellectual Property Office on Jun. 27, 2013, the entire contents of which are incorporated herein by reference.

### BACKGROUND

1. Field

The invention is related a method for manufacturing a display device, such as a flexible display device.

2. Description of the Related Art

A display device, such as an organic light emitting diode (OLED) display, may include a plastic film, a pixel circuit, and light emitting element, such as an OLED. The pixel circuit and the light emitting element may be formed on the plastic film. The plastic film may be substantially flexible, such that the display device may be substantially flexible.

In a typical process for manufacturing display devices, a mother plastic film is disposed on a rigid carrier substrate (e.g., a glass substrate), pixel circuits and light emitting elements may be formed on the mother plastic film, and subsequently the mother plastic film may be cut for separating individual display devices from each other.

The rigid carrier substrate may support the plastic film such that the plastic film may be substantially flat during the manufacturing process. For the individual display devices to be flexible, (portions of) the rigid carrier substrate should be separated from (portions of) the mother plastic film. Typically, cutting a structure that includes both the rigid carrier substrate and the mother plastic film may be technically difficult. Therefore, the rigid carrier substrate may be removed from the mother plastic film before the mother plastic film is cut. Nevertheless, without the support of the rigid carrier substrate, product defects may occur due to distortion and/or deformation at incisions of the mother plastic film.

The above information disclosed in this Background section is for enhancement of understanding of the background of the described technology. The Background section may contain information that does not form the prior art that is already known in this country to a person of ordinary skill in the art.

### SUMMARY

Embodiments of the invention may enable simultaneously manufacturing a plurality of display devices. Structures and/or shapes of the substrates (and components) of the display devices may be substantially maintained when the display devices are disconnected and/or separated from each other. Advantageously, quality of the display devices may be substantially ensured.

An embodiment of the invention may be related to a method for manufacturing a display device. The method may include forming a plurality of plastic films on a carrier substrate using a mask member. The plastic films may be spaced from each other and may include a first plastic film. The method may further include forming a display unit that includes a plurality of pixels on each of the plastic films, wherein a first display unit may be formed on the first plastic film. The method may further include separating the carrier substrate or portions of the carrier substrate from the plastic films to obtain a plurality of display devices that includes the display device. The display device may include the first plastic film and the first display unit. The first plastic film may function as a substrate of the display device.

The method may include the following step: cutting the carrier substrate at locations between the plastic films before the separating such that the portions of the carrier substrate are separated from each other.

The cutting may be performed using a cutting member. A distance between two immediately neighboring plastic films of the plastic films in a direction may be larger than a width of the cutting member in the direction.

The cutting member may directly contact the carrier substrate without directly contacting any of the plastic films.

The cutting may be performed at least along a cutting line that is equally distant from two immediately neighboring plastic films of the plastic films.

The method may include the following step: removing the mask member from the plastic films and/or from the carrier substrate before forming the first display unit on the first plastic film.

The method may include the following step: attaching the mask member to the carrier substrate such that the mask member contacts the carrier substrate before the forming of the plastic films. The mask member may have a plurality of openings that exposes portions of a surface of the carrier substrate.

The forming of the plurality of plastic films may include disposing a polymer material in the plurality of openings using spin coating, nozzle printing, and/or inkjet printing.

The method may include the following step: after the disposing of the polymer material, removing a solvent from the polymer material by performing a soft bake process.

The method may include the following steps: after the disposing of the polymer material, removing a solvent from the polymer material; and after the solvent has been substantially removed from the polymer material, remove the mask member from the carrier substrate.

The method may include the following steps: curing the polymer material; and after the curing, removing the mask member from the carrier substrate.

The first plastic film may comprise at least one of polyimide and polycarbonate.

Each of the pixels may comprise a thin film transistor, a capacitor, a pixel electrode, an organic emission layer, and a portion of a common electrode.

The method may include the following step: after the first display unit has been formed on the first plastic film, encapsulating the first display unit using an encapsulation layer.

A width of the encapsulation layer in a direction may be greater than or equal to a width of the first display unit in the direction and may be than or equal to a width of the first plastic film in the direction.

The encapsulation layer may include an organic layer and an inorganic layer that overlap each other.

The encapsulation layer may include organic layers and inorganic layers that are alternately stacked or alternately laminated.

The encapsulation layer may not directly contact the carrier substrate.

The method may include the following step: irradiating a laser beam to interfaces between the carrier substrate or the portions of the carrier substrate and the plastic films for separating the carrier substrate or the portions of the carrier substrate from the plastic films.

### BRIEF DESCRIPTION OF THE DRAWINGS

FIG. 1 is a process flowchart illustrating a method for manufacturing a display device (e.g., a flexible display device) according to an exemplary embodiment of the present invention.

FIG. 2A to FIG. 2C are schematic diagrams illustrating structures related to a step of the method illustrated in FIG. 1.

FIG. 3A is a schematic diagram illustrating a structure related to a step of the method illustrated in FIG. 1.

FIG. 3B is a cross-sectional view of the structure illustrated in FIG. 3A.

FIG. 4A and FIG. 4B are schematic diagrams illustrating structures related to a step of the method illustrated in FIG. 1.

FIG. 5A and FIG. 5B are schematic diagrams illustrating structures related to a step of the method illustrated in FIG. 1.

### DETAILED DESCRIPTION

The present invention is described more fully hereinafter with reference to the accompanying drawings, in which embodiments of the invention are shown. As those skilled in the art would realize, the described embodiments may be modified in various different ways, all without departing from the spirit or scope of the present invention.

In the description and claims, unless explicitly described to the contrary, the word “comprise” and variations, such as “comprises” or “comprising”, may mean inclusion of stated elements but may not suggest exclusion of any other elements. If an element, such as a layer, film, region, or substrate, is referred to as being “on” another element, it can be directly on the other element or an intervening element may also be present. The word “connect” may mean “electrically connect”. The word “insulate” may mean “electrically insulated”.

Although the terms “first”, “second”, etc. may be used herein to describe various signals, elements, components, regions, layers, and/or sections, these signals, elements, components, regions, layers, and/or sections should not be limited by these terms. These terms may be used to distinguish one signal, element, component, region, layer, or section from another signal, region, layer, or section. Thus, a first signal, element, component, region, layer, or section discussed below may be termed a second signal, element, component, region, layer, or section without departing from the teachings of the present invention. The description of an element as a “first” element may not require or imply the presence of a second element or other elements. The terms “first”, “second”, etc. may also be used herein to differentiate different categories of elements. For conciseness, the terms “first”, “second”, etc. may represent “first-type (or first-category)”, “second-type (or second-category)”, etc., respectively.

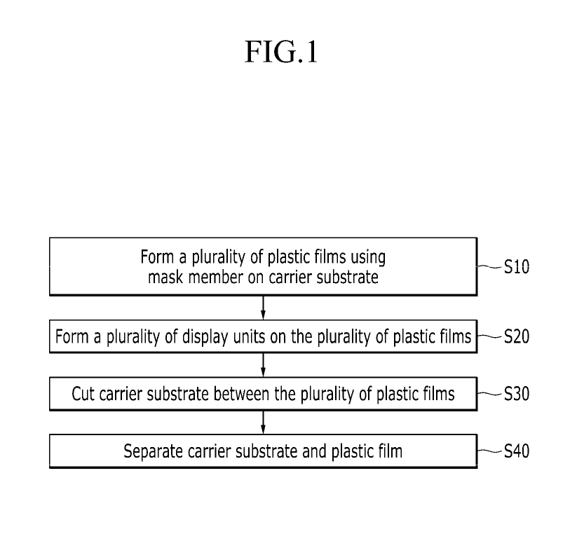

FIG. 1 is a flowchart illustrating a method for manufacturing display device (e.g., a flexible display device) according to an exemplary embodiment of the present invention.

Referring to FIG. 1, the method for manufacturing the flexible display device includes a first step S10 for forming a plurality of plastic films disposed at a distance from each other on a carrier substrate using a mask member, a second step S20 for forming a display unit including a plurality of pixels on an upper portion of each of the plastic films, a third step S30 for cutting the carrier substrate at locations between the plurality of plastic films, and a fourth step S40 for separating portions of the carrier substrate from the plastic films.

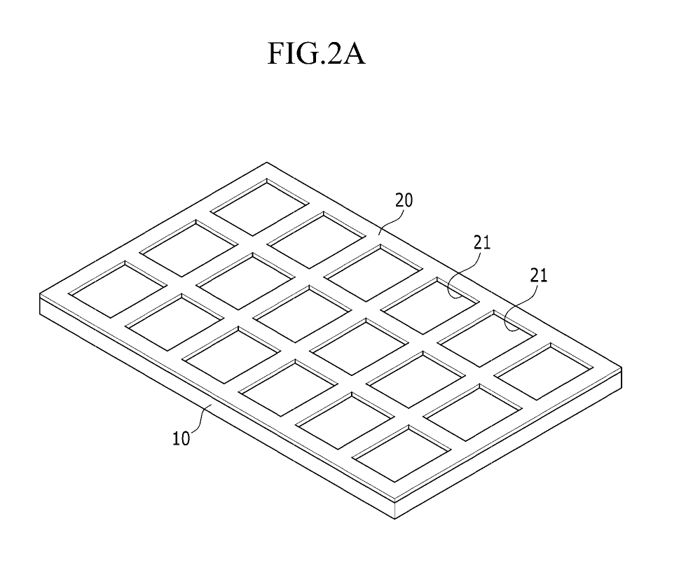

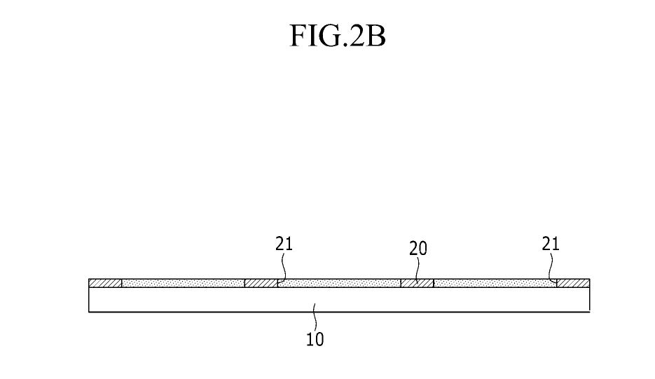

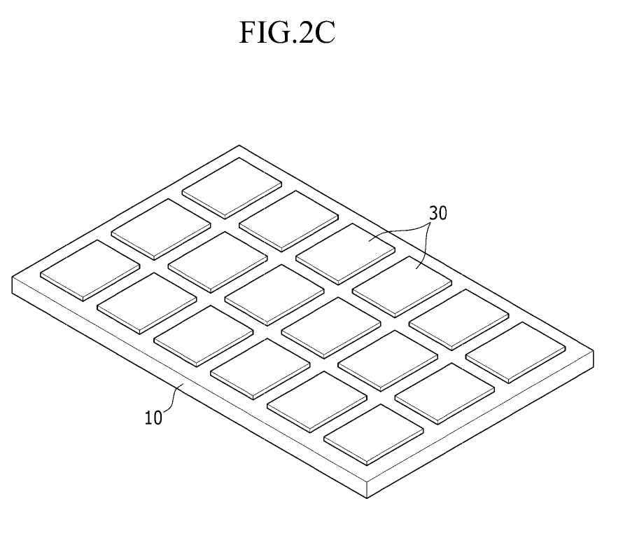

FIG. 2A to FIG. 2C are schematic diagrams of illustrating structures associate with the first step S10 shown in FIG. 1.

Referring to FIG. 2A, a carrier substrate 10 is prepared in the first step S10. A surface area of carrier substrate 10 is greater than the sum of top areas of a plurality of flexible display devices to be simultaneously manufactured.

The carrier substrate 10 may be mechanically strong and may not be substantially deformed when being exposed to heat. The carrier substrate 10 may be substantially transparent, for transmission of laser beams in the fourth step S40. For example, the carrier substrate 10 may be formed of transparent glass. The carrier substrate 10 may support members of the display devices such that the members may maintain surface flatness during one or more manufacturing steps.

A mask member 20 may be disposed on the carrier substrate 10. The mask member 20 may have a plurality of openings 21 for partially exposing a surface of the carrier substrate 10. The size of each opening 21 may correspond to the size of one flexible display device. The mask member 20 may be securely attached to the carrier substrate 10. The mask member 20 may be made of a metallic material or a non-metallic material.

Referring to FIG. 2B and FIG. 2C, the mask member 20 may function as a mold for forming separated plastic films 30. The openings 21 of the mask member 20 may be filled with a polymer material such that the plastic films 30 are formed and are spaced from each other. The plastic films 30 may be formed using one or more of various methods, such as a spin coating method, a drop method, a printing method (e.g., nozzle printing or inkjet printing), etc.

The polymer material may include a solvent. The solvent may be removed by performing a soft baking process at a temperature in a range of about 40° C. to 50° C. for a duration in a range of about 5 minutes to 8 minutes. After the solvent has been substantially removed from the plastic films 30, the mask member 20 may be removed from the carrier substrate 10.

If substantial solvent still exists in the plastic films 30 during the mask member 20 removal process, the mask member 20 may not be smoothly removed, and/or the plastic films 30 may be substantially deformed. Thus, in an embodiment, the mask member 20 is removed after the solvent is substantially eliminated.

After the mask member 20 has been removed from the carrier substrate 10, the plastic films 30 may be cured at a temperature in a range of about 400° C. to 450° C. for a duration in a range of about 360 minutes to 400 minutes. Each plastic film 30 may function as a substrate for supporting a display unit that includes a pixel circuit and an organic light emitting diode in a flexible display device.

The plastic film 30 may include polyimide or polycarbonate. Polyimide may be mechanically robust and may have a maximum operating temperature of about 450° C. Therefore, the plastic film 30 may function as a sufficiently stable substrate during formation process of a thin film transistor and/or an organic light emitting diode on the plastic film 30, in which high heat may be applied.

According to embodiments of the invention, the mask member 20 may be reused. The plastic films 30 may be separated without being cut or etched. Advantageously, costs associated with forming plastic films may be minimized, deformation of plastic films may be avoided, and satisfactory quality of the plastic films may be provided.

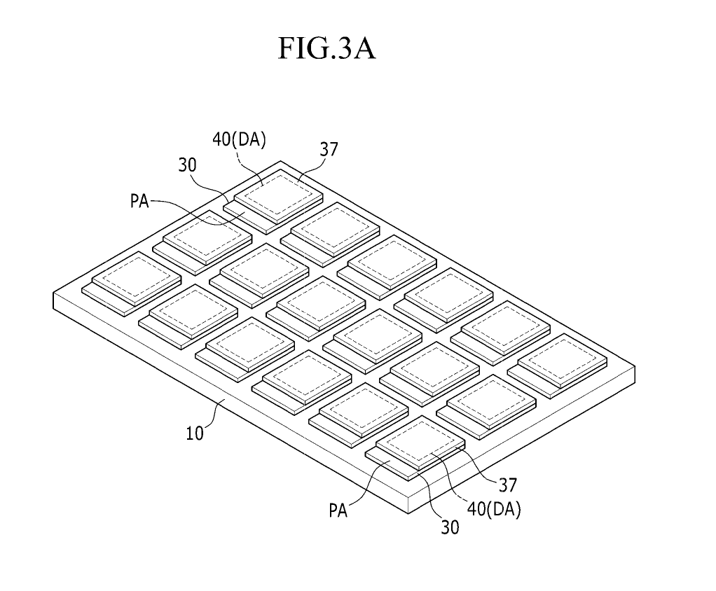

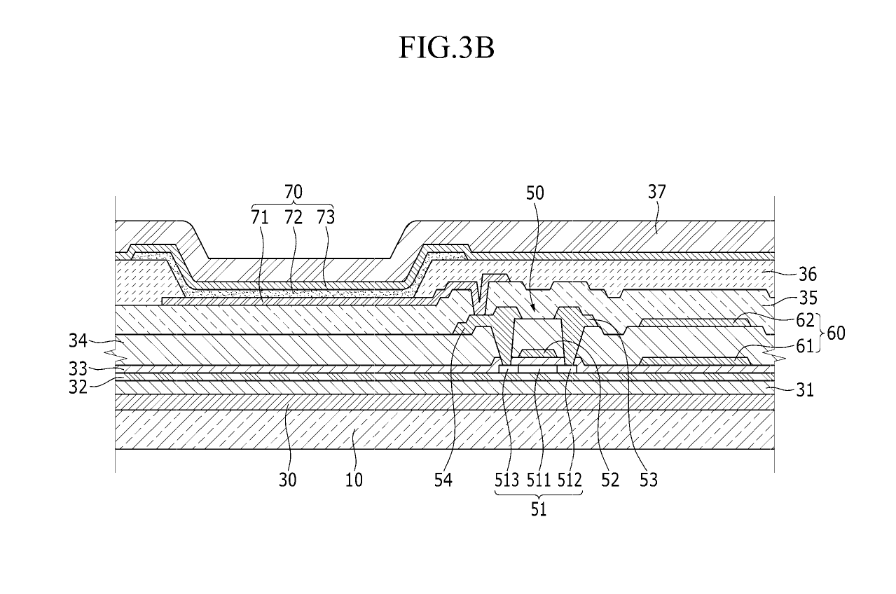

FIG. 3A is a schematic diagram illustrating a structure related to the second step S20 of the method illustrated in FIG. 1, and FIG. 3B is an cross-sectional view of the structure illustrated in FIG. 3A.

Referring to FIG. 3A, a display unit 40 including a plurality of pixels is formed on each plastic film 30. Each pixel may include a pixel circuit and an organic light emitting diode. Light emission of the organic light emitting diode may be controlled by the pixel circuit.

Referring to FIG. 3B, a barrier layer 31 is formed on the plastic film 30. The barrier layer 31 may include a plurality of inorganic layers, for example, a SiO₂ layer and a SiNx layer that overlap each other. The barrier layer 31 may have a water vapor transmission rate and a oxygen transmission rate that are lower than corresponding transmission rates of the plastic film 30; therefore, the barrier layer 31 may preventing moisture and oxygen that pass through the plastic film 30 from substantially permeating into the pixel circuit and the organic light emitting diode 70.

A buffer layer 32 is formed on the barrier layer 31. The buffer layer 32 is formed of an inorganic layer, which may include, for example, at least one of SiO₂, SiNx, SiON, AlO, and AlON. The buffer layer 32 provides a flat surface for forming the pixel circuit. The buffer layer 32 may further prevent moisture and oxygen from substantially permeating into the pixel circuit and the organic light emitting diode 70.

A thin film transistor 50 and a capacitor 60 are formed on the buffer layer 32. The thin film transistor 50 includes a semiconductor layer 51, a gate electrode 52, a source electrode 53, and a drain electrode 54. The semiconductor layer 51 is formed of polysilicon or an oxide semiconductor. The semiconductor layer 51 includes a channel area 511 (in which no substantial impurity is doped), a source area 512, and a drain area 513. The source area 512 and the drain area 513 are provided at opposite sides of the channel area 511 and are doped with impurities. In an embodiment, the semiconductor layer 51 is formed of an oxide semiconductor, and a protection layer may be provided for protection of the semiconductor layer 51.

A gate insulation layer 33 is provided between the semiconductor layer 51 and the gate electrode 52, and an interlayer insulation layer 34 is provided between the gate electrode 52 and the electrodes 53 and 54. The gate electrode 52 includes a metal (such as at least one of Al, Mg, Ni, Cr, Mo, W, MoW, Au, etc.) and may have a single-layer structure or a multi-layer structure. FIG. 3B illustrates that the thin film transistor 50 has a top gate structure. In an embodiment, the thin film transistor 50 may have a gate structure other than a top gate structure.

The capacitor 60 may include a first capacitive plate 61 (formed on the gate insulation layer 33) and a second capacitive plate 62 (formed on interlayer insulation layer 34). The first capacitive plate 61 may be formed of the same material as the gate electrode 52, and the second capacitive plate 62 may be formed of the same material as the source/drain electrodes 53 and 54. The second capacitive plate 62 may be connected to the source electrode 53.

The thin film transistor 50 shown in FIG. 3B is a driving thin film transistor, and the pixel circuit further includes a switching thin film transistor (not shown). The switching thin film transistor is used as a switching element that may control whether the associated pixel performs light emission, i.e., whether the pixel is switched on or switched off, and the driving thin film transistor may apply power to the pixel if the pixel is switched on. In a display device, a pixel may represent a minimum separately controllable unit for displaying an image, and the pixel circuit in the pixel may include at least two thin film transistors and at least one capacitor.

A planarization layer 35 is disposed on the source/drain electrodes 53 and 54 and the second capacitive plate 62. The planarization layer 35 may include an organic material, such as benzocyclobutene (BCB), acryl resin, epoxy resin, or phenol resin, and/or an inorganic material, such as SiNx. The planarization layer 35 has a via hole that partially exposes the drain electrode 54. The organic light emitting diode 70 is formed on the planarization layer 35.

The organic light emitting diode 70 includes a pixel electrode 71, an organic emission layer 72, and a common electrode 73. The pixel electrode 71 is insulated from other pixels and is connected to the drain electrode 54 of the thin film transistor 50 through the via hole. The pixel electrode 71 is surrounded by a pixel defining layer 36 that insulates pixel electrodes, and the organic emission layer 72 is formed on a portion of the pixel electrode 71 that is exposed by an opening of the pixel defining layer 36. The common electrode 73 overlaps both the organic emission layer 72 and the pixel defining layer 36 and overlaps pixel electrodes of a plurality of pixels.

The organic emission layer 72 may be one of a red emission layer, a green emission layer, and a blue emission layer. In an embodiment, the organic emission layer 72 may be a white emission layer. In an embodiment, the organic emission layer 72 may be a stacked layer that includes a red emission layer, a green emission layer, and a blue emission layer. In an embodiment, the organic emission layer 72 is a stacked layer, and the flexible display device may further include a color filter (not shown).

One of the pixel electrode 71 and the common electrode 73 is an anode, which is a hole injection electrode, and the other one is a cathode, which is an electron injection electrode. Holes (injected from the anode) and electrons (injected from the cathode) may combine in the organic emission layer 52 to generate excitons, and light may be emitted when the excitons discharge energy.

At least one of a hole injection layer and a hole transport layer may be positioned between the anode and the organic emission layer 72, and at least one of an electron injection layer and an electron transport layer may be positioned between the organic emission layer 72 and the cathode. The hole injection layer, the hole transport layer, the electron transport layer, and the electron injection layer may be formed on the entire display area of the display device and may overlap a plurality of pixel electrodes.

One of the pixel electrode 71 and the common electrode 73 may be a reflective layer and the other may be a transflective or transparent conductive layer. Light emitted from the organic emission layer 72 may be reflected from the reflective layer and transmitted through the transparent conductive layer 53 to be viewable to a viewer of the display device. In an embodiment, the common electrode 73 is a transflective layer, and some of the light reflected from the reflective pixel electrode 71 may be reflected back to the pixel electrode 71, such that luminance may be maximized through a resonant structure.

Thin film encapsulation layers 37 may be formed on a plurality of organic light emitting diodes 70. Each thin film encapsulating layer 37 encapsulates an organic light emitting diode 70 to separate the organic light emitting diode 70 from moisture and oxygen in the external environment, for preventing or delaying deterioration of the organic light emitting diode 70. The thin film encapsulating layer 37 may include a plurality of organic layers and a plurality of inorganic layers that are alternately stacked.

An organic layer of the thin film encapsulating layer 37 may be formed of one or more polymers and may be a single layer or a stacked layer (which include a plurality of stacked layers) formed of one or more of, for example, polyethyleneterephthalate, polyimide, polycarbonate, epoxy, polyethylene, and polyacrylate. An inorganic layer of the thin film encapsulating layer 37 may be a single layer or a stacked layer containing a metal oxide and/or a metal nitride. For example, the inorganic layer may contain one or more of SiNx, Al2O3, SiO2, and TiO2.

Referring to FIG. 3A and FIG. 3B, the thin film encapsulation layers 37 do not contact the carrier substrate 10. A width of the thin film encapsulation layer 37 is greater than a width of the display unit 40 and is equal to or less than a width of the plastic film 30. The encapsulation layer 37 may not cover or overlap (in a direction perpendicular to the top surface of the carrier substrate 10) surface portions of the carrier substrate 10 that are located between plastic films 30 are not covered by the plurality of plastic films 30, such that the surface portions may remain exposed even after the thin film encapsulation layer 37 is formed.

Referring to FIG. 3A, each plastic film 30 may include a display area DA and a pad area PA immediately adjacent to the display area DA. A display unit 40 may be disposed in the display area DA, and a thin film encapsulation layer 37 may cover the display area DA such that the display unit 40 may be encapsulated. Wires may extend from the display unit 40 to the pad area PA.

In an embodiment, an encapsulation layer 37 may be made of the same material as a plastic film 30. The encapsulation layer 37 may be connected to an edge of the plastic film 30 and may be shaped or moved to cover a display unit 40 after the display unit 40 has been disposed on the plastic film 30.

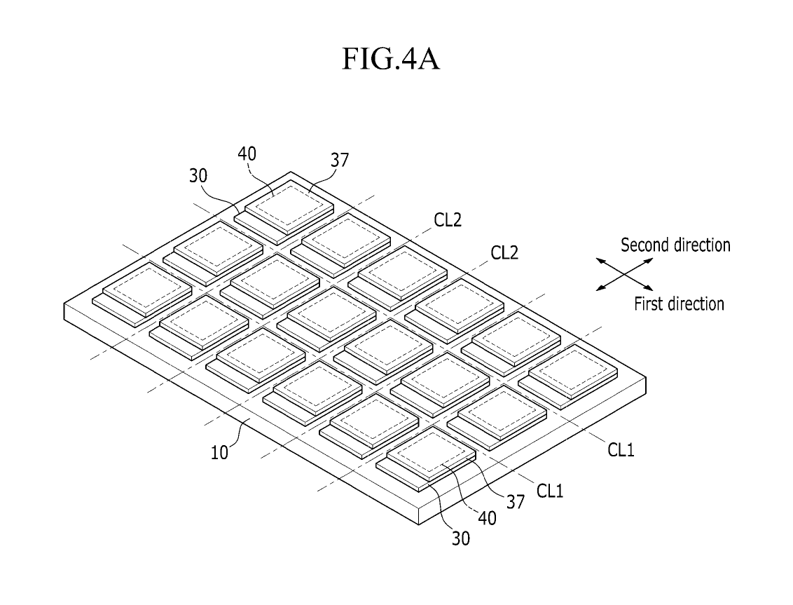

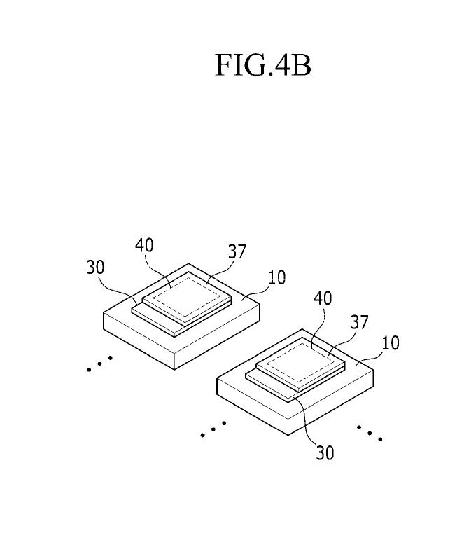

FIG. 4A and FIG. 4B are schematic diagrams illustrating structures related to the third step S30 of the method illustrated in FIG. 1.

Referring to FIG. 4A and FIG. 4B, cutting lines CL1 and CL2 are set (and/or marked) on the carrier substrate 10 at locations between the plurality of plastic films 30. The cutting lines CL1 and CL2 may include first-type cutting lines CL1 (or first cutting lines CL1) and second-type cutting lines CL2 (or second cutting lines CL2). The first cutting lines CL1 may extend in a first direction and may be parallel to a first edge of the carrier substrate 10. The second cutting lines CL2 may extend in a second direction and may parallel to a second edge of the carrier substrate 10. Each of the first cutting lines CL1 and/or each of the second cutting lines CL2 may be equally distant from two immediately neighboring plastic films 30 without being too close to either of the two plastic films 30.

The carrier substrate 10 may be cut along the first cutting lines CL1 (into stick-shaped units) and then cut along the second cutting lines CL2 (into units each including only one plastic film 30). The cutting processes can be performed using a cutting wheel, such as a diamond wheel. Since the plastic films 30 are substantially spaced from each other, the cutting processes may not substantially affect the structures and shapes of the plastic films 30, the display units 40, and the encapsulation layers 37. Advantageously, quality of the associated display devices may be maintained.

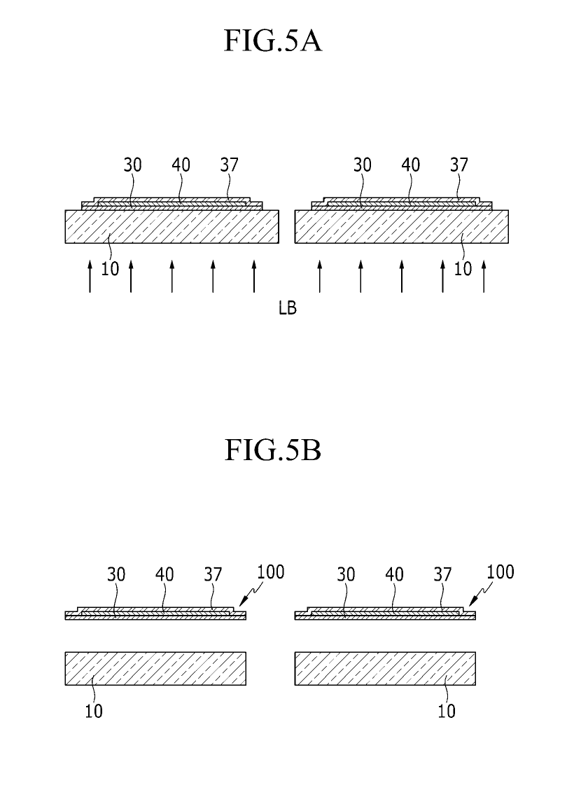

FIG. 5A and FIG. 5B are schematic diagrams illustrating structures related to the fourth step S40 of the method illustrated in FIG. 1.

Referring to FIG. 5A and FIG. 5B, a laser beam LB may be applied to separate the carrier substrate 10 from the plastic films 30. The laser beam LB may be irradiated to interfaces between the carrier substrate 10 and the plastic films 30 such that the carrier substrate 10 and the plastic films 30 are separated from each other.

The laser beam LB may be, for example, an optical coherence laser having a wavelength in a range of 100 nm to 350 nm. The laser beam LB may be one of a XeCI laser, a KrF laser, an ArF laser, and so on. Display device 100 (each including a plastic film 30 as a substrate) can be obtained after the carrier substrate 10 is removed from the plastic films 30. The plastic films 30 may be substantially flexible, and the display devices 100 may be flexible display devices.

Alternatively or additionally, the carrier substrate 10 and the plastic films 30 can be separated using other methods. In an embodiment, an intermediate layer is provided between the carrier substrate 10 and the plastic film 30, and the intermediate layer may be removed using a chemical material or heat to thereby separate the carrier substrate 10 from the plastic films 30.

In an embodiment, the third step S30 may be omitted, and display devices 100 may be obtained by removing the carrier substrate 10 from the plastic films 30. Since the plastic films 30 are spaced from each other, the display devices 100 may be disconnected from each other once the carrier substrate 10 is removed.

According to embodiments of the invention, the plastic film 30, which functions as the substrate of the flexible display device 100, is not cut by a cutting tool. Therefore, the structure and shape of the plastic film 30 (and components disposed thereon) may be substantially maintained without substantial distortion. Advantageously, quality of the plastic films 30 (and components disposed thereon) may be ensured.

In an embodiment, the manufactured display device may include a display element and/or a light emitting element other than an organic light emitting diode. In an embodiment, the display device may be a liquid crystal display (LCD) and may include an alignment layer, a liquid crystal layer, and a color filter layer instead of or in addition to an organic light emitting diode (OLED). In an embodiment, the plastic film 30 may be substantially rigid without being very flexible.

While this disclosure has been described in connection with what is presently considered to be practical embodiments, it is to be understood that the invention is not limited to the described embodiments. The invention is intended to cover various modifications and equivalent arrangements included within the spirit and scope of the appended claims.

What is claimed is:

1. A method for manufacturing a display device, the method comprising:
forming a plurality of plastic films on a carrier substrate using a mask member, the plastic films being spaced from each other and including a first plastic film;
forming a display unit that includes a plurality of pixels on each of the plastic films, a first display unit being formed on the first plastic film; and
separating the carrier substrate or portions of the carrier substrate from the plastic films to obtain a plurality of display devices that includes the display device, the display device including the first plastic film and the first display unit.

2. The method of claim 1, further comprising: cutting the carrier substrate at locations between the plastic films before the separating such that the portions of the carrier substrate are separated from each other.

3. The method of claim 2, wherein the cutting is performed using a cutting member, and wherein a distance between two immediately neighboring plastic films of the plastic films in a direction is larger than a width of the cutting member in the direction.

4. The method of claim 3, wherein the cutting member contacts the carrier substrate without directly contacting any of the plastic films.

5. The method of claim 2, wherein the cutting is performed at least along a cutting line that is equally distant from two immediately neighboring plastic films of the plastic films.

6. The method of claim 1, further comprising: removing the mask member from the plastic films before forming the first display unit on the first plastic film.

7. The method claim 1, further comprising: attaching the mask member to the carrier substrate such that the mask member contacts the carrier substrate before the forming of the plastic films, wherein the mask member has a plurality of openings that exposes portions of a surface of the carrier substrate.

8. The method of claim 7, wherein the forming of the plurality of plastic films includes disposing a polymer material in the plurality of openings using one of spin coating, nozzle printing, and inkjet printing.

9. The method of claim 8, further comprising: after the disposing of the polymer material, removing a solvent from the polymer material by performing a soft bake process.

10. The method of claim 8, further comprising:
after the disposing of the polymer material, removing a solvent from the polymer material; and
after the solvent has been substantially removed from the polymer material, remove the mask member from the carrier substrate.

11. The method claim 8, further comprising:
curing the polymer material; and
after the curing, removing the mask member from the carrier substrate.

12. The method of claim 1, wherein the first plastic film comprises at least one of polyimide and polycarbonate.

13. The method of claim 1, wherein each of the pixels comprises a thin film transistor, a capacitor, a pixel electrode, an organic emission layer, and a portion of a common electrode.

14. The method of claim 1, further comprising: after the first display unit has been formed on the first plastic film, encapsulating the first display unit using an encapsulation layer.

15. The method of claim 14, wherein a width of the encapsulation layer in a direction is greater than or equal to a width of the first display unit in the direction and is less than or equal to a width of the first plastic film in the direction.

16. The method of claim 14, wherein the encapsulation layer includes an organic layer and an inorganic layer that overlap each other.

17. The method of claim 14, wherein the encapsulation layer does not directly contact the carrier substrate.

18. The method claim 1, further comprising: irradiating a laser beam to interfaces between the carrier substrate or the portions of the carrier substrate and the plastic films for performing the separating.
